(19) United States
(12) Patent Application Publication
(10) Pub. No.: US 2024/0233097 A1
(43) Pub. Date: Jul. 11, 2024

(54) ENVIRONMENT CAPTURE AND RENDERING

(71) Applicant: APPLE INC., Cupertino, CA (US)

(72) Inventors: Long H. NGO, San Jose, CA (US); Alexandre DA VEIGA, San Francisco, CA (US)

(21) Appl. No.: 18/582,835

(22) Filed: Feb. 21, 2024

Related U.S. Application Data
(63) Continuation of application No. PCT/US2022/041831, filed on Aug. 29, 2022.
(60) Provisional application No. 63/242,825, filed on Sep. 10, 2021.

(51) Int. Cl. G06T 5/77; G06T 11/40; G06T 17/20; G06T 19/00

(52) U.S. Cl. CPC G06T 5/77; G06T 11/40; G06T 17/20; G06T 19/00; G06T 2207/10028; G06T 2219/024

(57) ABSTRACT

Various implementations disclosed herein include devices, systems, and methods that generate 2D views of a 3D environment using a 3D point cloud where the cloud points selected for each view are based on a low-resolution 3D mesh. In some implementations, a 3D point cloud of a physical environment is obtained, the 3D point cloud including points each having a 3D location and representing an appearance of a portion of the physical environment. Then, a 3D mesh is obtained corresponding to the 3D point cloud, and a 2D view of the 3D point cloud from a viewpoint is generated using a subset of the points of the 3D point cloud, where the subset of points is selected based on the 3D mesh.

### CROSS-REFERENCE TO RELATED APPLICATIONS

This patent application is a continuation of International Application No. PCT/US2022/041831 (International Publication No. WO2023/038820) filed on Aug. 29, 2022, which claims priority of U.S. Provisional Application No. 63/242,825 filed on Sep. 10, 2021, both entitled “ENVIRONMENT CAPTURE AND RENDERING,” each of which is incorporated herein by this reference in its entirety.

### TECHNICAL FIELD

The present disclosure generally relates to rendering a point cloud representation of a physical environment and, in particular, to capturing and rendering the point cloud representation of the physical environment in an extended reality environment.

### BACKGROUND

There exists a need for improved techniques that are capable of providing real-time renderings of representations of physical environments using 3D point clouds.

### SUMMARY

Various implementations disclosed herein include devices, systems, and methods that renders views of a 3D environment using a 3D point cloud where cloud points are rendered based on a low-resolution 3D mesh. In some implementations, a 2D view of the 3D environment is generated from a viewpoint using a subset of the points of the 3D point cloud, where the subset of points is selected based on the low-resolution 3D mesh. For example, depth information from the low-resolution 3D mesh may be used to ensure that occluded 3D cloud points are not used in generating the views. In some implementations, the depth information of the low-resolution 3D mesh is also used to select which 3D cloud points are used for inpainting the 2D views. In some implementations, the 3D point cloud and the low-resolution 3D mesh are obtained, and the 2D view of the 3D point cloud is rendered at a prescribed frame rate (e.g., 60 Hz) to provide an XR environment based on the viewpoint. Using a low-resolution 3D mesh according to techniques disclosed herein may enable more efficient generation of consistent, stable views of the 3D environment.

In general, one innovative aspect of the subject matter described in this specification can be embodied in methods that include the actions of obtaining a 3D point cloud of a physical environment, the 3D point cloud including points each having a 3D location and representing an appearance of a portion of the physical environment, and obtaining a 3D mesh corresponding to the 3D point cloud. Then, a 2D view of the 3D point cloud is generated from a viewpoint using a subset of the points of the 3D point cloud, where the subset of points is selected based on the 3D mesh.

### BRIEF DESCRIPTION OF THE DRAWINGS

So that the present disclosure can be understood by those of ordinary skill in the art, a more detailed description may be had by reference to aspects of some illustrative implementations, some of which are shown in the accompanying drawings.

FIG. 1 a diagram that illustrates an electronic device displaying a frame of a sequence of frames that includes an XR environment in a physical environment in accordance with some implementations.

FIG. 2 is a diagram that illustrates an exemplary rendering process for 3D representations of a physical environment from a viewpoint using 3D point clouds in accordance with some implementations.

FIG. 3 is a diagram that illustrates an exemplary stereo inpainted view-dependent model (IVDM) based on a 3D representation of a physical environment in accordance with some implementations.

FIG. 4 is a diagram that illustrates an exemplary rendering process for 3D representations of a physical environment from a viewpoint using 3D point clouds in accordance with some implementations.

FIG. 5 is a flowchart illustrating an exemplary method of rendering views of a 3D environment using a 3D point cloud in accordance with some implementations.

FIG. 6 is a flowchart illustrating an exemplary method of rendering views of a 3D environment using a 3D point cloud in accordance with some implementations.

FIG. 7 illustrates an example electronic device in accordance with some implementations.

In accordance with common practice, the various features illustrated in the drawings may not be drawn to scale. Accordingly, the dimensions of the various features may be arbitrarily expanded or reduced for clarity. In addition, some of the drawings may not depict all of the components of a given system, method or device. Finally, like reference numerals may be used to denote like features throughout the specification and figures.

### DESCRIPTION

Numerous details are described in order to provide a thorough understanding of the example implementations shown in the drawings. However, the drawings merely show some example aspects of the present disclosure and are therefore not to be considered limiting. Those of ordinary skill in the art will appreciate that other effective aspects or variants do not include all of the specific details described herein. Moreover, well-known systems, methods, components, devices and circuits have not been described in exhaustive detail so as not to obscure more pertinent aspects of the example implementations described herein.

Various implementations disclosed herein include devices, systems, and methods that render a view of a 3D environment using a 3D point cloud where the cloud points are rendered based on depth information from a low-resolution mesh. The depth information may be used to ensure that occluded cloud points are not used in generating a view by determining which cloud points to (a) project or (b) remove and then project remaining points. The depth information may be used to select which cloud points are used for inpainting the view. The use of a 3D point cloud with a low-resolution mesh avoids the high processing costs of rendering using only a high-resolution mesh while avoiding the occlusion/instability issues of using only a 3D point cloud. Other information from the low-resolution mesh, e.g., surface normal information, may be used to further enhance the view.

In some implementations, a user uses an electronic device to scan the physical environment (e.g., room) to generate a 3D representation of the physical environment. In some implementations, the electronic device uses computer vision techniques and combinations of sensors to scan the physical environment to generate a 3D point cloud as the 3D representation of the physical environment. In some implementations, a low-resolution 3D mesh is generated based on the 3D point cloud. For example, the 3D mesh may be a low-resolution mesh with vertices between 1-8 centimeters apart that include depth information for surfaces of the 3D representation of the physical environment. In some implementations, a 2D view of the 3D point cloud is generated from a viewpoint (e.g., of the capturing electronic device) using a subset of the points of the 3D point cloud, where the subset of points (e.g., visible or unoccluded points) is selected based on the depth information of the low-resolution 3D mesh. In some implementations, 3D points representing a flat portion or 2D surface in the 3D point cloud are identified and the identified 3D points (e.g., a 2D surface) are replaced with a planar element. For example, the planar element can be an image or texture representing that 2D surface. The planar surface images or textured planar surfaces can replace the corresponding points in the 3D point cloud to reduce the amount of data to represent the physical environment.

When the user of the electronic device wants to share the representation of the physical environment, the electronic device transmits the 1) 3D point cloud, 2) low-resolution mesh, and 3) textured planar surfaces that were generated for each frame to a remote electronic device used by a remote user. The remote electronic device can use the same 3D point cloud, the low-resolution mesh, and the textured planar surfaces to render each frame.

In some implementations, the remote electronic device will project the 3D point cloud into a 2D display space (e.g., for each eye of the remote user) based on a viewpoint (e.g., of the remote electronic device). The low-resolution 3D mesh is used when projecting the 3D points into the 2D display space. Again, the depth information of the low-resolution 3D mesh is used to project only visible cloud points of the 3D point cloud (e.g., exclude occluded points). The 2D projection of the 3D point cloud is combined with the textured planar surfaces. For example, the 2D projection of the 3D point cloud is combined with a representation of the textured planar surfaces in the 2D display space.

Then, a 2D inpainting process is performed on the combined 2D projection and the representation of the textured planar surfaces in some implementations. The 2D inpainting process results in a complete (e.g., no gaps or holes) view of the representation of the physical environment (e.g., inpainted view dependent model (IVDM)). The 2D inpainting only fills gaps in 2D display space with color values. In some implementations, the depth information of the low-resolution 3D mesh is used to determine which cloud points of the 3D point cloud to use when inpainting.

The inpainted image or 2D view for each eye is displayed at the remote electronic device based on the viewpoint of the remote electronic device. In some implementations, the inpainted image (e.g., for each eye) is composited with any virtual content that is in the XR environment before display.

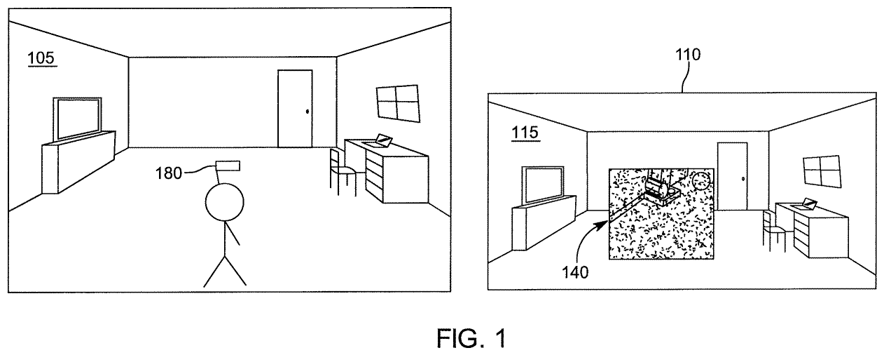

As shown in FIG. 1, an XR environment is provided based on a 3D representation of a remote physical environment (e.g., wall and floor) using 3D point clouds. In some implementations, the 3D representation is played back frame-by frame as an inpainted view dependent model (IVDM) 140. As shown in FIG. 1, a display 110 of an electronic device 180 is presenting an XR environment in a view 115 of a physical environment 105 in a display 110. The XR environment may be generated from a frame of a sequence of frames based on 1) a 3D point cloud and 2) low-resolution mesh received or accessed by the electronic device 180, for example, when executing an application in the physical environment 105. As shown in FIG. 1, the electronic device 180 presents XR environment including the IVDM 140 in a view 115 on the display 110.

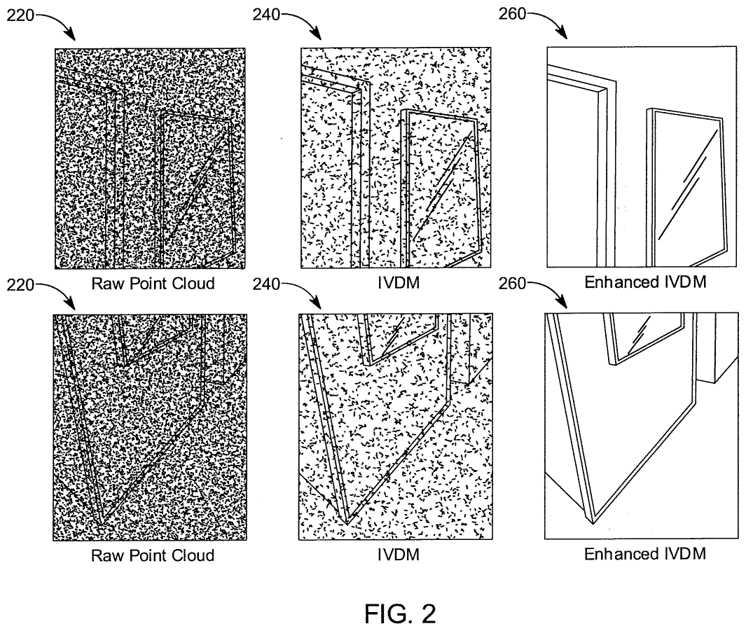

FIG. 2 illustrates a diagram of an exemplary rendering process for 3D representations of a physical environment using 3D point clouds. The rendering process is played back in real time and is viewable from different positions. A capturing electronic device and a playback electronic device can be the same electronic device or different (e.g., remote) electronic devices.

As shown in FIG. 2, a 3D point cloud 220 (e.g., raw data) is captured and is a 3D representation of a physical environment. In some implementations, the captured 3D point cloud 220 is processed and then is played back (e.g., frame-by-frame) as an IVDM 240 that can be viewed from different positions or viewpoints. In some implementations, the IVDM 240 is further modified by a 2D surface enhancement procedure and rendered as enhanced IVDM 260. The IVDM 240 or the enhanced IVDM 260 can be generated as a 2D view or a 3D view (e.g., stereoscopic) of the 3D representation of the physical environment.

As shown in FIG. 2, the 3D point cloud 220 is very noisy when displayed and close items can be unrecognizable. In some areas, close points and distant points in the 3D point cloud appear together. Other areas of the 3D point cloud 220 appear transparent or contain noticeable gaps between points. For example, parts of a wall appear through a painting or points behind the wall or the floor are visible.

In contrast, the IVDM 240 uses occlusion to determine what points of the 3D point cloud 220 to project into a 2D display space to generate the IVDM 240. Thus, the IVDM 240 has more detail, is smoother, and surfaces/edges of objects are clearer and visible. As shown in FIG. 2, the doors, walls, and painting appear solid and separate from each other in the IVDM 240.

Similarly, the enhanced IVDM 260 further improves the rendering of planar surfaces such as walls, floors, flat sides or flat portions of objects, etc. In some implementations, the IVDM 240 (e.g., 2D or stereoscopic views) are enhanced by replacing corresponding points (e.g., of the 3D point cloud) representing an identified planar surface with a planar element in the 2D view. For example, the planar element can be an image representing that planar surface. In another example, the planar element can be a texture representing that planar surface. In some implementations, the planar element has a higher image quality or resolution than the projected 3D point cloud points forming the IVDM 240.

In some implementations, a low-resolution 3D mesh or 3D model is generated (e.g., in the 3D point cloud capture process). For example, the low-resolution 3D mesh and 3D point cloud 220 are independently generated for each frame. In some implementations, the 3D point cloud is accumulated over time, and the low-resolution mesh (or textured planar surfaces) are continuously generated or refined for each selected frame (e.g., keyframe). In some implementations, the low-resolution 3D mesh includes polygons (e.g., triangles) with vertices, for example, between 1 and 10 centimeters apart or between 4 and 6 centimeters apart. In some implementations, the low-resolution 3D mesh is generated by running a meshing algorithm on the captured 3D point cloud 220. In some implementations, a depth map is determined based on the low-resolution 3D mesh. The depth map may include a depth value for each of the vertices in the low-resolution 3D mesh. For example, the depth map indicates how far each vertex of the 3D mesh is from a sensor capturing the 3D point cloud.

In some implementations, in order to render the IVDM 240 representation using the 3D point cloud 220, occlusion for the individual points in the 3D point cloud 220 is determined. Instead of using the 3D point cloud 220, IVDM techniques use the low-resolution 3D mesh to determine occlusion. For example, points in the 3D point cloud 220 that are below or behind the low-resolution 3D mesh when viewed from a particular viewpoint are not used to determine or render the IVDM 240 from that viewpoint. In some implementations, the low-resolution 3D mesh may be used to further enhance the IVDM 240 (e.g., surface normal, inpainting, de-noising, etc.).

In some implementations, depth information is determined for vertices or surfaces of the low-resolution 3D mesh. For example, a depth map indicates how far the low-resolution 3D mesh is from the 3D point cloud sensor. Then, relevant points of the 3D point cloud 220 are projected into 2D display space based on their position with respect to the low-resolution 3D mesh. In some implementations, a thresholding technique uses the low-resolution 3D mesh to determine the relevant points of the 3D point cloud 220 in each frame. In some implementations, the low-resolution 3D mesh determines points of the 3D point cloud 220 to keep and project. Alternatively, the low-resolution 3D mesh determines points of the 3D point cloud 220 to discard and the remaining 3D point cloud points are projected. For example, the occluded points that are behind the low-resolution 3D mesh are not projected into 2D display space (e.g., there is no analysis of those points).

For example, the low-resolution 3D mesh identifies that a surface of an object (floor, desk) is only 3 feet away so that 3D point cloud 220 points in that direction (e.g., in a 2D projection) that are under/behind the object and 6 feet away are not included in the 2D projection (e.g., or used for inpainting).

The use of a 3D point cloud 220 with a low-resolution 3D mesh reduces or avoids the high processing costs of rendering using only a high-resolution 3D mesh while avoiding the occlusion or instability issues of using only a 3D point cloud. Using the 3D point cloud 220 for occlusion can result in frame to frame incoherence, especially when the vantage point of the rendered captured environment is changing. In contrast, the low-resolution 3D mesh is stable, which reduces frame to frame incoherence. In addition, the low-resolution 3D mesh is efficient from a processing point of view, which is especially important because the view dependent rendering will not use the same frame twice. Further, as described herein, the low-resolution 3D mesh may be have too low of a resolution to be used for rendering the actual playback 3D representation of the physical environment.

Once the 3D point cloud 220 is projected into the 2D display space (e.g., for one or both eyes) for a frame, any holes or gaps in the projection may need to be addressed. In some implementations, the low-resolution 3D mesh is used to determine how to inpaint any holes or gaps in the projection. For example, the color of points on the 3D point cloud 220 are used to inpaint any holes in the projected views based on depth information in the low-resolution 3D mesh. For example, the low-resolution 3D mesh is used to determine occlusion of 3D points to prevent inpainting using 3D points that are visible through the 3D point cloud, but that should be occluded. In one implementation, depth information of the low-resolution 3D mesh may be used to identify points of the 3D point cloud for inpainting a color to fill in a hole (e.g., based on color and depth of adjacent or nearby points in the 3D point cloud 220). For example, the inpainting may be performed using 3D points within a threshold distance from a surface of the low-resolution 3D mesh or 3D points located in front and within a threshold distance of a surface of the low-resolution 3D mesh. In some implementations, the inpainting only fills gaps in 2D space with color values. In some implementations, the inpainted image for each eye is then composited with any virtual content that is included in the scene in the XR environment.

Inpainting the enhanced IVDM 260 also fills gaps or holes in the projection and uses the same techniques based on the depth information of the low-resolution 3D mesh. In this case, the inpainting provides uniform, consistent appearance across the enhanced IVDM 260 (e.g., between the projected 3D points and the projected textured planar surfaces).

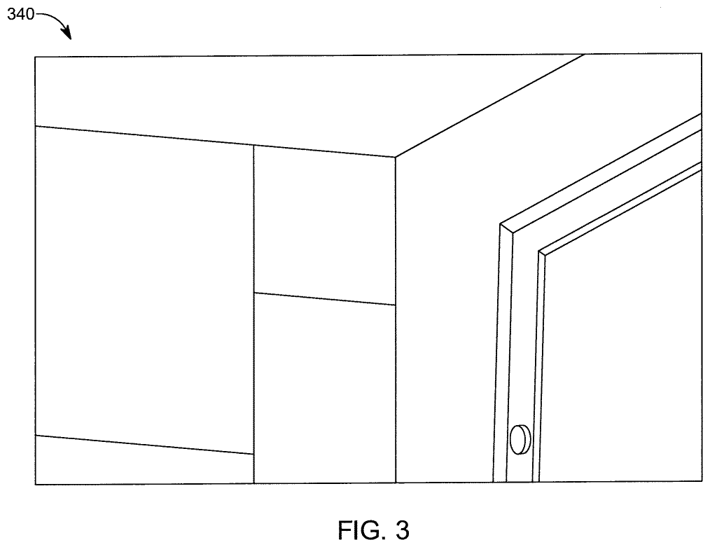

FIG. 3 is a diagram that illustrates an exemplary stereo IVDM based on a 3D representation of a physical environment. As shown in FIG. 3, a stereo IVDM 340 can be generated as a 3D view (e.g., stereoscopic) of the 3D representation of the physical environment (e.g., 3D point cloud 220) from a viewpoint. In some implementations, the stereo IVDM 340 includes two locations corresponding to eyes of a user and generates a stereoscopic pair of images for the eyes of the user to render a stereoscopic view of the IVDM 340 in an XR experience or environment.

In some implementations, surface normals of the low-resolution 3D mesh are determined. The orientation of polygons (e.g., triangles) determined by vertices of the low-resolution 3D mesh is determined and then a surface normal is defined orthogonal to the orientation. In some implementations, surface normals of the low-resolution 3D mesh are used when providing a view of the captured 3D environment (e.g., lighting) or when providing interactions with the playback 3D environment (e.g., graphics, physics effects). For example, knowing the orientation of surfaces of the playback 3D environment enables accurate lighting effects (e.g., shadows) and user interactions like bouncing a virtual ball on the representation of a floor, desk, or wall.

In some implementations, the XR environment should include an indication that the IVDM (e.g., 240, 340) is not the physical environment. Accordingly, when the user of the electronic device or the electronic device approaches within a prescribed distance, a visual appearance of the IVDM in the XR environment is changed. For example, the IVDM in the XR environment within a distance threshold becomes transparent, dissolves, or disappears. For example, any portion of the IVDM within 2 feet of the playback electronic device (or user) disappears.

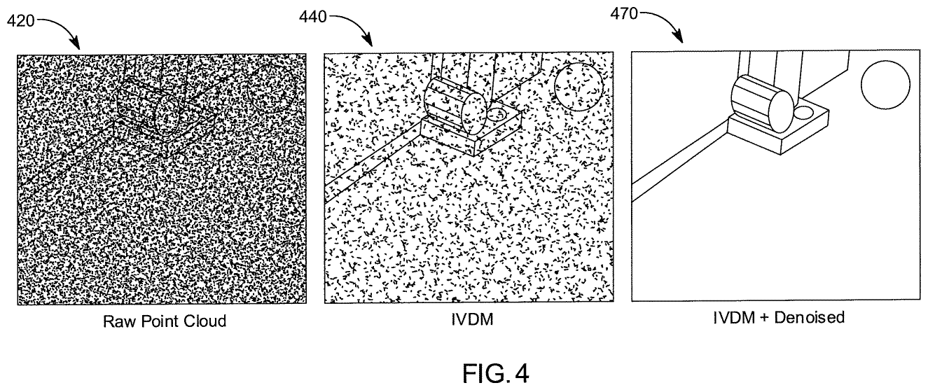

FIG. 4 illustrates a diagram of an exemplary rendering process for 3D representations of a physical environment using 3D point clouds. As shown in FIG. 4, a 3D point cloud 420 (e.g., raw data) is captured and is a 3D representation of a physical environment. The captured 3D point cloud 420 is processed and then is played back as an IVDM 440 as described herein that can be viewed from different positions or viewpoints. In some implementations, the IVDM 440 is further modified by a noise filtering operation and rendered as denoised IVDM 470.

In some implementations, a noise filtering operation (e.g., image filtering) is performed on the IVDM 440 (e.g., the inpainted images for each eye). For example, the noise filtering reduces noise, while preserving edges to increase sharpness of the inpainted images. In some implementations, the noise filtering uses bilateral filtering that calculates a blending weight depending on how closely matched the color or depth information is between neighboring pixels. For example, when two neighboring pixels are closely related, they can be blended to reduce noise. However, when larger differences in color, brightness, or depth exist between the pixels, there is no blending to maintain details and edges in the inpainted images. Thus, in some implementations, depth from the low-resolution mesh is used with color blending and edge detection in the noise filtering that results in the denoised IVDM 470. In some implementations, the de-noised image (e.g., for each eye) is then composited with any virtual content to be rendered with the IVDM in the XR environment.

In some implementations, a single concurrent real time capturing and real-time rendering process (e.g., remote) provides a 2D/3D viewpoint (e.g., point cloud representation) of an extended reality (XR) environment. In these implementations, an initial delay may occur until the 3D point cloud reaches a preset size or is of sufficient quality to render an IVDM in the XR environment. In these implementations, data transfers are completed at a sufficient rate (e.g., 1× per second) for concurrent real-time rendering. In some implementations, a rendering point cloud is synthesized based on the size of the captured 3D point cloud and processing capabilities of the intended rendering electronic device. Further, any positional updates/loop closures are gradually implemented over time to reduce or prevent discernable corrections. In some implementations, the single process is divided into a first capture process (e.g., offline) and a second real-time rendering process. In an offline capture process, the 1) 3D point cloud, 2) low-resolution mesh, and 3) textured planar surfaces that were generated to represent 2D surfaces for each frame are stored. In some implementations, the 3D point cloud is accumulated over time, and the low-resolution mesh (or textured planar surfaces) are continuously generated or refined for each selected frame (e.g., keyframe). In some implementations, between capture and render, an optional clean-up operation is performed on the 3D point cloud (e.g., outliers, data sufficiency, positional updates/loop closures). Alternatively, a rendering point cloud is synthesized based on the size of the captured 3D point cloud and processing capabilities of the intended rendering electronic device (e.g., the rendering electronic device is capable of generating an IVDM at the intended frame rate using the rendering point cloud). In some implementations, during the real-time rendering process the 3D point cloud, the low-resolution mesh, and the textured planar surfaces are static.

In some implementations, the electronic device uses known techniques and combinations of sensors to scan the physical environment to render a 2D/3D representation of the physical environment (e.g., 3D point cloud). In some implementations, Visual Inertial Odometry (VIO) or Simultaneous Localization and Mapping (SLAM) tracks 6 DOF movement of an electronic device in a physical environment (e.g., 3 DOF of spatial (xyz) motion (translation), and 3 DOF of angular (pitch/yaw/roll) motion (rotation) in real-time. In some implementations, the electronic device also uses the computer vision techniques and combinations of sensors to track the position of the electronic device in the physical environment or XR environment (e.g., in-between every displayed frame).

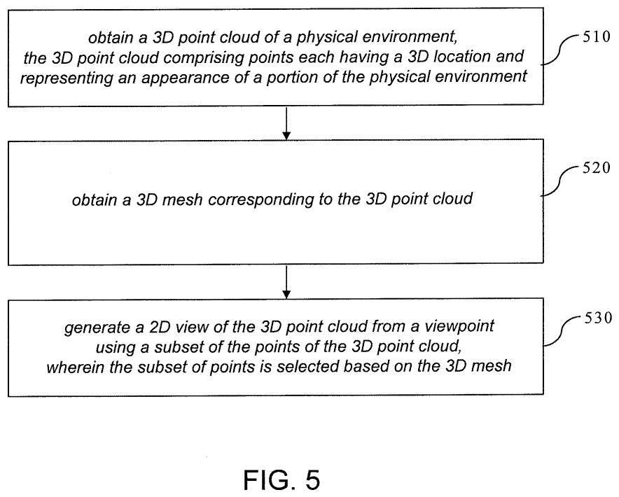

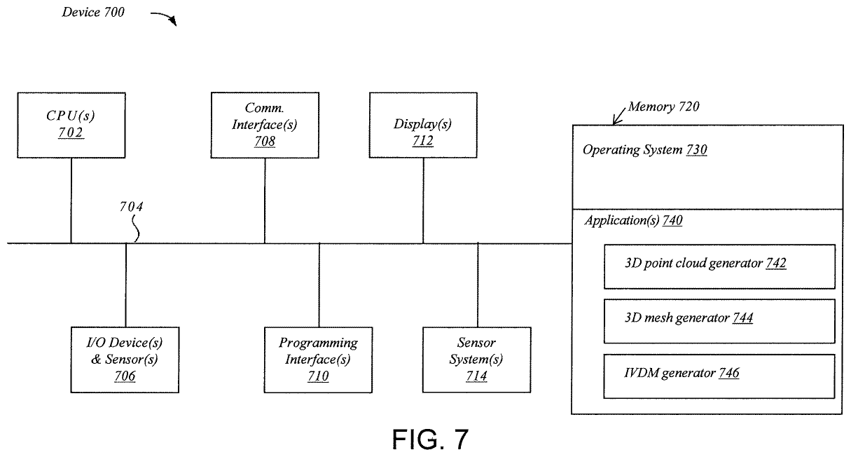

FIG. 5 is a flowchart illustrating an exemplary method of rendering views of a 3D environment using a 3D point cloud where the cloud points are rendered based on a low-resolution 3D mesh. In some implementations, a 2D view of the 3D point cloud is generated from a viewpoint using a subset of the points of the 3D point cloud, where the subset of points is selected based on the low-resolution 3D mesh. For example, depth information from the low-resolution 3D mesh ensures that occluded 3D cloud points are not used in generating the views. In some implementations, the depth information of the low-resolution 3D mesh is also used to select which 3D cloud points are used for inpainting the 2D views. In some implementations, the low-resolution 3D mesh generates consistent stable views while reducing processing requirements to generate the views. In some implementations, the 3D point cloud and the low-resolution 3D mesh are obtained, and the 2D view of the 3D point cloud is rendered at a prescribed frame rate in an XR environment based on the viewpoint. In some implementations, the method 500 is performed by a device (e.g., electronic device 700 of FIG. 7). The method 500 can be performed using an electronic device or by multiple devices in communication with one another. In some implementations, the method 500 is performed by processing logic, including hardware, firmware, software, or a combination thereof. In some implementations, the method 500 is performed by a processor executing code stored in a non-transitory computer-readable medium (e.g., a memory). In some implementations, the method 500 is performed by an electronic device having a processor.

At block 510, the method 500 obtains a 3D point cloud of a physical environment, the 3D point cloud including points each having a 3D location and representing an appearance (e.g., colors) of a portion of the physical environment. In some implementations, the 3D point cloud was previously generated and stored. In some implementations, the 3D point cloud was captured by a first electronic device. In some implementations, the 3D point cloud is intended for a multi-user communication session or extended reality (XR) experience.

At block 520, the method 500 obtains a 3D mesh corresponding to the 3D point cloud. In some implementations, the 3D mesh is generated based on the 3D point cloud. For example, a low-resolution meshing algorithm uses the 3D point cloud to create the 3D mesh with acceptable quality. In some implementations, the 3D mesh is a low-resolution 3D mesh with vertices between 1-8 centimeters apart. In some implementations, the 3D mesh was previously generated and stored.

At block 530, the method 500 generates a 2D view (e.g., a 2D projection) of the 3D point cloud from a viewpoint using a subset of the points of the 3D point cloud, where the subset of points is selected based on the 3D mesh. In some implementations, the subset of points is projected into a 2D display space to generate the 2D view (e.g., a 2D projection). In some implementations, the subset of points is selected based on depth information from the 3D mesh. In some implementations, the subset of points is selected by excluding points of the 3D point cloud that are determined to be occluded based on the 3D mesh (e.g., depth information from the 3D mesh). For example, the depth information from the 3D mesh determines which cloud points to project into the 2D view. In some implementations, the occluded points of the 3D point cloud are removed to obtain the subset of points, which are used to generate the 2D view.

In some implementations, the method 500 enhances the 2D view by replacing corresponding 2D points representing an identified 2D surface with a planar element in the 2D view. In some implementations, the method 500 inpaints the 2D view or the enhanced 2D view to modify color information of the 2D view. For example, depth information from the 3D mesh is used to select which cloud points of the 3D point cloud are used for inpainting the 2D view.

In some implementations, an image filtering operation is performed on the inpainted 2D view (e.g., de-noising based on depth of the 3D mesh). The 2D view of the 3D point cloud is separately generated for each frame of an XR environment.

In some implementations, the 3D point cloud and the 3D mesh corresponding to the 3D point cloud are generated in a previous capture session (e.g., offline) and stored. Then, the 3D point cloud and the 3D mesh are obtained by accessing the stored 3D point cloud and stored 3D mesh, respectively, and the 2D view of the 3D point cloud is rendered at a prescribed frame rate in an XR environment based on the viewpoint.

In some implementations, the 3D point cloud is captured at a frame rate at a first electronic device (e.g., capturing electronic device) located in the physical environment, and the 3D mesh corresponding to the 3D point cloud is generated at the frame rate by the first electronic device. In some implementations, the 2D view of the 3D point cloud is concurrently rendered at the frame rate in an extended reality environment based on the viewpoint by the first electronic device (e.g., real-time capture and display).

In some implementations, the 3D point and the 3D mesh are obtained by a second electronic device (e.g., playback electronic device) receiving the 3D point cloud and the 3D mesh from the first electronic device, respectively, and the 2D view of the obtained 3D point cloud is concurrently rendered at the frame rate in an XR environment based on the viewpoint by the second electronic device (e.g., real-time local capture and remote display). Optionally, the 3D point cloud (e.g., size) obtained by the first electronic device is based on the processing capabilities of the second electronic device.

In some implementations, the 2D view of the 3D point cloud further includes virtual content. In some implementations, the 2D view of the 3D point cloud further includes a virtual representation (e.g., avatars) of the user of the rendering electronic device and the user of other participating electronic devices for a multi-user communication session. In some implementations, the real-time rendering process can provide multiple 2D viewpoints of the XR environment for a multi-user XR environment.

In some implementations, a portion of the 2D view of the 3D mesh is removed or visually modified based on the 3D mesh. For example, a portion of the 2D view of the 3D mesh is removed or rendered translucently when the user of the rendering electronic device (or another participating electronic device in a multi-user communication session) is too close to the 2D view.

In some implementations, blocks 510-530 are repeatedly performed. In some implementations, the techniques disclosed herein may be implemented on a smart phone, tablet, or a wearable device, such as an HMD having an optical see-through or opaque display. In some implementations, blocks 510-530 may be performed for two different viewpoints corresponding to each eye of a user to generate a stereo view of the 3D environment represented by the 3D point cloud.

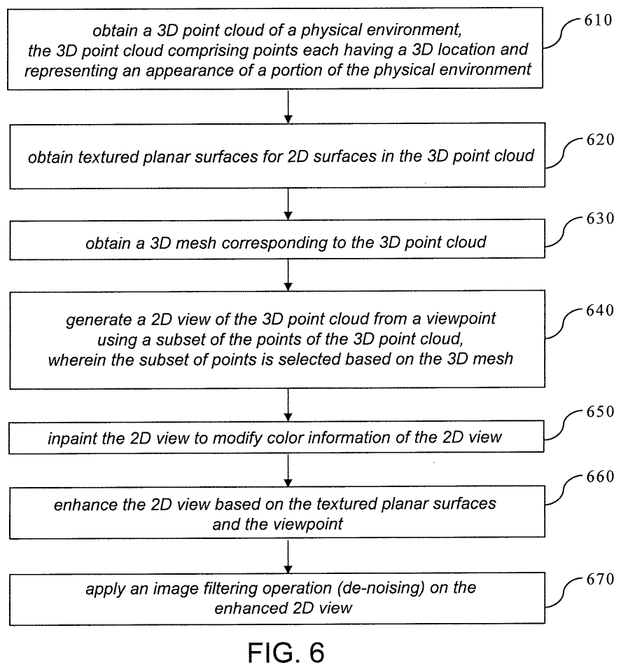

FIG. 6 is a flowchart illustrating an exemplary method of rendering views of a 3D environment using a 3D point cloud where the cloud points are rendered based on a low-resolution 3D mesh. In some implementations, a 2D view of the 3D point cloud is generated from a viewpoint using a subset of the points of the 3D point cloud, where the subset of points is selected based on the low-resolution 3D mesh. For example, depth information from the low-resolution 3D mesh ensures that occluded 3D cloud points are not used in generating the views. In some implementations, the depth information of the low-resolution 3D mesh is also used to select which 3D cloud points are used for inpainting the 2D views. In some implementations, the low-resolution 3D mesh is also used to render textured planar surfaces that represent flat surfaces identified the 3D point cloud in the views. In some implementations, the method 600 is performed by a device (e.g., electronic device 700 of FIG. 7). The method 600 can be performed using an electronic device or by multiple devices in communication with one another. In some implementations, the method 600 is performed by processing logic, including hardware, firmware, software, or a combination thereof. In some implementations, the method 600 is performed by a processor executing code stored in a non-transitory computer-readable medium (e.g., a memory). In some implementations, the method 600 is performed by an electronic device having a processor.

At block 610, the method 600 obtains a 3D point cloud of a physical environment, the 3D point cloud including points each having a 3D location and representing an appearance (e.g., colors) of a portion of the physical environment. In some implementations, the 3D point cloud was previously generated and stored. In some implementations, the 3D point cloud was captured by a first electronic device. In some implementations, the 3D point cloud is intended for a multi-user communication session or extended reality (XR) experience.

At block 620, the method 600 obtains textured planar elements for 2D surfaces in the 3D point cloud. In some implementations, 3D points representing flat portions or 2D surfaces in the 3D point cloud are identified and the identified 3D points (e.g., a 2D surface) are replaced with textured planar elements. For example, the textured planar element can be an image representing a 2D surface identified in the 3D point cloud. In some implementations, the planar element has a high image quality.

At block 630, the method 600 obtains a 3D mesh corresponding to the 3D point cloud. In some implementations, the 3D mesh is generated based on the 3D point cloud. For example, a low-resolution meshing algorithm uses the 3D point cloud to create the 3D mesh with acceptable quality. In some implementations, the 3D mesh is a low-resolution 3D mesh with vertices between 1-8 centimeters apart. In some implementations, the 3D mesh was previously generated and stored.

At block 640, the method 600 generates a 2D view (e.g., a 2D projection) of the 3D point cloud from a viewpoint using a subset of the points of the 3D point cloud, where the subset of points is selected based on the 3D mesh. In some implementations, the subset of points is projected into a 2D display space to generate the 2D view. In some implementations, the subset of points is selected based on depth information from the 3D mesh. In some implementations, the subset of points is selected by excluding points of the 3D point cloud that are determined to be occluded based on the 3D mesh (e.g., depth information from the 3D mesh).

At block 650, the method 600 inpaints the 2D view to modify color information of the 2D view. In some implementations, any holes or gaps in the 2D view (e.g., for one or both eyes) are inpainted. In some implementations, the low-resolution 3D mesh is used to determine how to inpaint the holes or gaps in the 2D view. For example, depth information from the 3D mesh is used to select which cloud points of the 3D point cloud are used for inpainting the 2D view. The 2D inpainting process results in a complete 2D view (e.g., inpainted view dependent model (IVDM)). The 2D inpainting only fills gaps in 2D view with color values.

At block 660, the method 600 enhances the 2D view based on the textured planar elements and the viewpoint. In some implementations, enhancing the 2D view improves the rendering of 2D surfaces such as walls, floors, flat sides or flat portions of objects that are in the 2D view. In some implementations, the 2D view is enhanced by rendering corresponding points representing an identified 2D surface with a planar element in the 2D view. The 2D view can be enhanced by rendering identified 2D surfaces in the 2D view based on the textured planar elements and the low-resolution 3D mesh.

In some implementations, block 660 may be performed before block 650 such that corresponding points representing an identified 2D surface of the 2D view generated at block 640 may be rendered with a planar element. The enhanced 2D view may then be inpainted as described above with respect to block 650.

At block 670, the method 600 applies an image filtering operation on the enhanced 2D view. In some implementations, a noise image filtering operation is performed on the enhanced 2D view. For example, the noise filtering reduces noise, while preserving edges to increase sharpness of the inpainted images. In some implementations, the noise image filtering uses bilateral filtering that calculates a blending weight depending on how closely matched the color or depth information is between neighboring pixels. In some implementations, depth from the low-resolution mesh is used with color blending and edge detection in the noise image filtering of the enhanced 2D view.

At block 670, the method renders the 2D view of the 3D point cloud for each frame of an XR environment. In some implementations, the 2D view is composited with any virtual content to be rendered with the 2D view in the XR environment.

In some implementations, the 3D point cloud, the 3D mesh, and the textured planar elements corresponding to flat surfaces in the 3D point cloud are generated in a previous capture session (e.g., offline) and stored. Then, the 3D point cloud, the 3D mesh, and the textured planar elements are obtained by accessing the stored the 3D point cloud, the stored 3D mesh, and the stored textured planar elements, respectively, and the 2D view of the 3D point cloud is rendered at a prescribed frame rate in an XR environment based on the viewpoint.

In some implementations, the 3D point cloud is captured at a frame rate at a first electronic device (e.g., capturing electronic device) located in the physical environment, and the 3D mesh, and the textured planar elements are generated at the frame rate by the first electronic device and concurrently rendered at the frame rate in an extended reality environment based on the viewpoint by the first electronic device (e.g., real-time capture and display). In some implementations, the 2D view of the obtained 3D point cloud is concurrently rendered at the frame rate in an XR environment based on the viewpoint by a remote second electronic device (e.g., real-time local capture and remote display) that obtained the 3D point cloud, the 3D mesh, and the textured planar elements. In some implementations, the 2D view of the 3D point cloud further includes a virtual representation (e.g., avatars) of the user of the rendering electronic device and the user of other participating electronic devices for a multi-user communication session.

In some implementations, blocks 610-630 are repeatedly performed. In some implementations, the techniques disclosed herein may be implemented on a smart phone, tablet, or a wearable device, such as an HMD having an optical see-through or opaque display. In some implementations, blocks 610-670 may be performed for two different viewpoints corresponding to each eye of a user to generate a stereo view of the 3D environment represented by the 3D point cloud.

FIG. 7 is a block diagram of an example device 700. While certain specific features are illustrated, those skilled in the art will appreciate from the present disclosure that various other features have not been illustrated for the sake of brevity, and so as not to obscure more pertinent aspects of the implementations disclosed herein. To that end, as a non-limiting example, in some implementations the electronic device 700 includes one or more processing units 702 (e.g., microprocessors, ASICs, FPGAs, GPUs, CPUs, processing cores, or the like), one or more input/output (I/O) devices and sensors 706, one or more communication interfaces 708 (e.g., USB, FIREWIRE, THUNDERBOLT, IEEE 802.3x, IEEE 802.11x, IEEE 802.16x, GSM, CDMA, TDMA, GPS, IR, BLUETOOTH, ZIGBEE, SPI, 12C, or the like type interface), one or more programming (e.g., I/O) interfaces 710, one or more displays 712, one or more interior or exterior facing sensor systems 714, a memory 720, and one or more communication buses 704 for interconnecting these and various other components.

In some implementations, the one or more communication buses 704 include circuitry that interconnects and controls communications between system components. In some implementations, the one or more I/O devices and sensors 706 include at least one of an inertial measurement unit (IMU), an accelerometer, a magnetometer, a gyroscope, a thermometer, one or more physiological sensors (e.g., blood pressure monitor, heart rate monitor, blood oxygen sensor, blood glucose sensor, etc.), one or more microphones, one or more speakers, a haptics engine, one or more depth sensors (e.g., a structured light, a time-of-flight, or the like), or the like.

In some implementations, the one or more displays 712 are configured to present content to the user. In some implementations, the one or more displays 712 correspond to holographic, digital light processing (DLP), liquid-crystal display (LCD), liquid-crystal on silicon object (LCoS), organic light-emitting field-effect transitory (OLET), organic light-emitting diode (OLED), surface-conduction electron-emitter display (SED), field-emission display (FED), quantum-dot light-emitting diode (QD-LED), micro-electromechanical system (MEMS), or the like display types. In some implementations, the one or more displays 712 correspond to diffractive, reflective, polarized, holographic, etc. waveguide displays. For example, the electronic device 700 may include a single display. In another example, the electronic device 700 includes a display for each eye of the user.

In some implementations, the one or more interior or exterior facing sensor systems 714 include an image capture device or array that captures image data or an audio capture device or array (e.g., microphone) that captures audio data. The one or more image sensor systems 714 may include one or more RGB cameras (e.g., with a complimentary metal-oxide-semiconductor (CMOS) image sensor or a charge-coupled device (CCD) image sensor), monochrome cameras, IR cameras, or the like. In various implementations, the one or more image sensor systems 714 further include an illumination source that emits light such as a flash. In some implementations, the one or more image sensor systems 714 further include an on-camera image signal processor (ISP) configured to execute a plurality of processing operations on the image data.

The memory 720 includes high-speed random-access memory, such as DRAM, SRAM, DDR RAM, or other random-access solid-state memory devices. In some implementations, the memory 720 includes non-volatile memory, such as one or more magnetic disk storage devices, optical disk storage devices, flash memory devices, or other non-volatile solid-state storage devices. The memory 720 optionally includes one or more storage devices remotely located from the one or more processing units 702. The memory 720 comprises a non-transitory computer readable storage medium.

In some implementations, the memory 720 or the non-transitory computer readable storage medium of the memory 720 stores an optional operating system 730 and one or more instruction set(s) 740. The operating system 730 includes procedures for handling various basic system services and for performing hardware dependent tasks. In some implementations, the instruction set(s) 740 include executable software defined by binary information stored in the form of electrical charge. In some implementations, the instruction set(s) 740 are software that is executable by the one or more processing units 702 to carry out one or more of the techniques described herein.

In some implementations, the instruction set(s) 740 include a 3D point cloud generator 742, a 3D mesh generator 744, and a IVDM generator 746 that are executable by the processing unit(s) 702. In some implementations, the 3D point cloud generator 742 determines a 3D representation of a physical environment according to one or more of the techniques disclosed herein. In some implementations, the 3D mesh generator 744 determines a 3D mesh that includes depth information for surfaces of a 3D representation of a physical environment according to one or more of the techniques disclosed herein. In some implementations, the IVDM generator 746 uses determines a 2D view of the 3D representation of a physical environment using a subset of points in the 3D representation determined based on the low resolution 3D mesh from a viewpoint according to one or more of the techniques disclosed herein.

Although the instruction set(s) 740 are shown as residing on a single device, it should be understood that in other implementations, any combination of the elements may be located in separate computing devices. FIG. 7 is intended more as a functional description of the various features which are present in a particular implementation as opposed to a structural schematic of the implementations described herein. As recognized by those of ordinary skill in the art, items shown separately could be combined and some items could be separated. For example, actual number of instruction sets and the division of particular functions and how features are allocated among them will vary from one implementation to another and, in some implementations, depends in part on the particular combination of hardware, software, or firmware chosen for a particular implementation.

It will be appreciated that the implementations described above are cited by way of example, and that the present invention is not limited to what has been particularly shown and described hereinabove. Rather, the scope includes both combinations and sub combinations of the various features described hereinabove, as well as variations and modifications thereof which would occur to persons skilled in the art upon reading the foregoing description and which are not disclosed in the prior art.

Those of ordinary skill in the art will appreciate that well-known systems, methods, components, devices, and circuits have not been described in exhaustive detail so as not to obscure more pertinent aspects of the example implementations described herein. Moreover, other effective aspects and/or variants do not include all of the specific details described herein. Thus, several details are described in order to provide a thorough understanding of the example aspects as shown in the drawings. Moreover, the drawings merely show some example embodiments of the present disclosure and are therefore not to be considered limiting.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous.

Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

Embodiments of the subject matter and the operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, i.e., one or more modules of computer program instructions, encoded on computer storage medium for execution by, or to control the operation of, data processing apparatus. Alternatively, or additionally, the program instructions can be encoded on an artificially generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially generated propagated signal. The computer storage medium can also be, or be included in, one or more separate physical components or media (e.g., multiple CDs, disks, or other storage devices).

The term “data processing apparatus” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures. Unless specifically stated otherwise, it is appreciated that throughout this specification discussions utilizing the terms such as “processing,” “computing,” “calculating,” “determining,” and “identifying” or the like refer to actions or processes of a computing device, such as one or more computers or a similar electronic computing device or devices, that manipulate or transform data represented as physical electronic or magnetic quantities within memories, registers, or other information storage devices, transmission devices, or display devices of the computing platform.

The system or systems discussed herein are not limited to any particular hardware architecture or configuration. A computing device can include any suitable arrangement of components that provides a result conditioned on one or more inputs. Suitable computing devices include multipurpose microprocessor-based computer systems accessing stored software that programs or configures the computing system from a general purpose computing apparatus to a specialized computing apparatus implementing one or more implementations of the present subject matter. Any suitable programming, scripting, or other type of language or combinations of languages may be used to implement the teachings contained herein in software to be used in programming or configuring a computing device.

Implementations of the methods disclosed herein may be performed in the operation of such computing devices. The order of the blocks presented in the examples above can be varied for example, blocks can be re-ordered, combined, and/or broken into sub-blocks. Certain blocks or processes can be performed in parallel. The operations described in this specification can be implemented as operations performed by a data processing apparatus on data stored on one or more computer-readable storage devices or received from other sources.

The use of “adapted to” or “configured to” herein is meant as open and inclusive language that does not foreclose devices adapted to or configured to perform additional tasks or steps. Additionally, the use of “based on” is meant to be open and inclusive, in that a process, step, calculation, or other action “based on” one or more recited conditions or values may, in practice, be based on additional conditions or value beyond those recited. Headings, lists, and numbering included herein are for ease of explanation only and are not meant to be limiting.

It will also be understood that, although the terms “first,” “second,” etc. may be used herein to describe various elements, these elements should not be limited by these terms. These terms are only used to distinguish one element from another. For example, a first node could be termed a second node, and, similarly, a second node could be termed a first node, which changing the meaning of the description, so long as all occurrences of the “first node” are renamed consistently and all occurrences of the “second node” are renamed consistently. The first node and the second node are both nodes, but they are not the same node.

The terminology used herein is for the purpose of describing particular implementations only and is not intended to be limiting of the claims. As used in the description of the implementations and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” may be construed to mean “when” or “upon” or “in response to determining” or “in accordance with a determination” or “in response to detecting,” that a stated condition precedent is true, depending on the context. Similarly, the phrase “if it is determined [that a stated condition precedent is true]” or “if [a stated condition precedent is true]” or “when [a stated condition precedent is true]” may be construed to mean “upon determining” or “in response to determining” or “in accordance with a determination” or “upon detecting” or “in response to detecting” that the stated condition precedent is true, depending on the context.

The described technology may gather and use information from various sources. This information may, in some instances, include personal information that identifies or may be used to locate or contact a specific individual. This personal information may include demographic data, location data, telephone numbers, email addresses, date of birth, social media account names, work or home addresses, data or records associated with a user's health or fitness level, or other personal or identifying information.

The collection, storage, transfer, disclosure, analysis, or other use of personal information should comply with well-established privacy policies or practices. Privacy policies and practices that are generally recognized as meeting or exceeding industry or governmental requirements should be implemented and used. Personal information should be collected for legitimate and reasonable uses and not shared or sold outside of those uses. The collection or sharing of information should occur after receipt of the user's informed consent.

It is contemplated that, in some instances, users may selectively prevent the use of, or access to, personal information. Hardware or software features may be provided to prevent or block access to personal information. Personal information should be handled to reduce the risk of unintentional or unauthorized access or use. Risk can be reduced by limiting the collection of data and deleting the data once it is no longer needed. When applicable, data de-identification may be used to protect a user's privacy.

Although the described technology may broadly include the use of personal information, it may be implemented without accessing such personal information. In other words, the present technology may not be rendered inoperable due to the lack of some or all of such personal information.

1. A method comprising:
at a processor:
obtaining a three-dimensional (3D) point cloud of a physical environment, the 3D point cloud comprising points each having a 3D location and representing an appearance of a portion of the physical environment;
obtaining a 3D mesh corresponding to the 3D point cloud;
selecting a subset of points based on the 3D mesh; and
generating a two-dimensional (2D) view of the 3D point cloud from a viewpoint using the subset of the points of the 3D point cloud.

2. The method of claim 1, wherein the subset of points is selected by excluding points of the 3D point cloud that are determined to be occluded based on the 3D mesh.

3. The method of claim 1, wherein generating the 2D view comprises projecting the subset of points into a 2D display space to generate the 2D view.

4. The method of claim 1, wherein generating the 2D view comprises:
removing the occluded points of the 3D point cloud to obtain the subset of points; and
generating the 2D view by projecting the subset of points based on the viewpoint.

5. The method of claim 1, further comprising enhancing the 2D view by replacing corresponding 2D points representing an identified 2D surface using a planar element in the 2D view.

6. The method of claim 5, further comprising inpainting the enhanced 2D view to modify color information of the enhanced 2D view.

7. The method of claim 1, further comprising inpainting the 2D view to modify color information of the 2D view.

8. The method of claim 1, wherein the 2D view of the 3D point cloud is separately generated for each frame of an extended reality experience.

9. The method of claim 1, further comprising performing an image filtering operation on the inpainted 2D view.

10. The method of claim 1, wherein:
the 3D point cloud and the 3D mesh corresponding to the 3D point cloud are generated in a previous capture session and stored;
obtaining the 3D point could comprises accessing the stored 3D point cloud;
obtaining the 3D mesh comprises accessing the stored 3D mesh; and
the method further comprises rendering the 2D view of the 3D point cloud at a prescribed frame rate in an extended reality environment based on the viewpoint.

11. The method of claim 1, wherein the 3D point cloud is captured at a frame rate at a first electronic device located in the physical environment, and wherein the 3D mesh corresponding to the 3D point cloud is generated at the frame rate by the first electronic device.

12. The method of claim 11, wherein:
obtaining the 3D point cloud comprises receiving, by a second electronic device, the 3D point cloud from the first electronic device;
obtaining the obtained 3D mesh comprises receiving, by the second electronic device, the 3D mesh from the first electronic device; and
the method further comprises concurrently rendering, by the second electronic device, the 2D view of the obtained 3D point cloud at the frame rate.

13. The method of claim 12, wherein the obtained 3D point cloud is based on the processing capabilities of the second electronic device.

14. The method of claim 12, wherein the 2D view of the 3D point cloud further comprises a virtual representation of a user of the first electronic device for a multi-user communication session.

15. The method of claim 1, wherein the 2D view of the 3D point cloud further comprises virtual content.

16. The method of claim 1, further comprising:
generating surface normals for polygons identified using vertices in the 3D mesh; and
modifying the 2D view of the 3D point cloud and virtual content for visual effects or user interactions based on the surface normals.

17. The method of claim 1, wherein the 3D mesh is generated by executing a meshing algorithm on the 3D point cloud, and wherein the 3D mesh is a low-resolution mesh with vertices between 1-6 centimeters apart.

18. The method of claim 1, wherein a portion of the 2D view of the 3D mesh is removed or visually modified based on the 3D mesh.

19. (canceled)

20. A system comprising:
memory; and
one or more processors at a device coupled to the memory, wherein the memory comprises program instructions that, when executed on the one or more processors, cause the system to perform operations comprising:
obtaining a three-dimensional (3D) point cloud of a physical environment, the 3D point cloud comprising points each having a 3D location and representing an appearance of a portion of the physical environment;
obtaining a 3D mesh corresponding to the 3D point cloud;
selecting a subset of points based on the 3D mesh; and
generating a two-dimensional (2D) view of the 3D point cloud from a viewpoint using the subset of the points of the 3D point cloud.

21-38. (canceled)

39. A non-transitory computer-readable storage medium, storing program instructions executable via one or more processors to perform operations comprising:
obtaining a three-dimensional (3D) point cloud of a physical environment, the 3D point cloud comprising points each having a 3D location and representing an appearance of a portion of the physical environment;
obtaining a 3D mesh corresponding to the 3D point cloud;
selecting a subset of points based on the 3D mesh; and
generating a two-dimensional (2D) view of the 3D point cloud from a viewpoint using the subset of the points of the 3D point cloud.

40-57. (canceled)
